(19) United States
(12) Patent Application Publication
(10) Pub. No.: US 2018/0307669 A1
(43) Pub. Date: Oct. 25, 2018

(54) INFORMATION PROCESSING APPARATUS

(71) Applicant: FUJI XEROX CO., LTD., Tokyo (JP)

(72) Inventors: Shotaro Misawa, Kanagawa (JP); Tomoko Okuma, Kanagawa (JP); Tomoki Taniguchi, Kanagawa (JP); Motoki Taniguchi, Kanagawa (JP)

(73) Assignee: FUJI XEROX CO., LTD., Tokyo (JP)

(21) Appl. No.: 15/832,529

(22) Filed: Dec. 5, 2017

(30) Foreign Application Priority Data
Apr. 25, 2017 (JP) 2017-085884

(51) Int. Cl. G06F 17/27; G06F 15/18

(52) U.S. Cl. CPC G06F 17/2705; G06F 17/30861; G06F 15/18

(57) ABSTRACT

An information processing apparatus includes a first extraction unit, a second extraction unit, and a notification unit. The first extraction unit extracts tags which co-occur in a document. The second extraction unit extracts a co-occurrence probability or an expected value of the number of co-occurrences of the co-occurring tags extracted by the first extraction unit from a co-occurrence probability or an expected value of the number of co-occurrences between the tags which is calculated with respect to a document which has already been tagged. The notification unit notifies that the co-occurring tags extracted by the first extraction unit are abnormal based on the co-occurrence probability or the expected value of the number of co-occurrences extracted by the second extraction unit.

### CROSS-REFERENCE TO RELATED APPLICATIONS

This application is based on and claims priority under 35 USC 119 from Japanese Patent Application No. 2017-085884 filed Apr. 25, 2017.

### BACKGROUND

### Technical Field

The present invention relates to an information processing apparatus.

### SUMMARY

According to an aspect of the invention, an information processing apparatus includes a first extraction unit, a second extraction unit, and a notification unit. The first extraction unit extracts tags which co-occur in a document. The second extraction unit extracts a co-occurrence probability or an expected value of the number of co-occurrences of the co-occurring tags extracted by the first extraction unit from a co-occurrence probability or an expected value of the number of co-occurrences between the tags which is calculated with respect to a document which has already been tagged. The notification unit notifies that the co-occurring tags extracted by the first extraction unit are abnormal based on the co-occurrence probability or the expected value of the number of co-occurrences extracted by the second extraction unit.

### BRIEF DESCRIPTION OF THE DRAWINGS

Exemplary embodiments of the present invention will be described in detail based on the following figures, wherein:

FIG. 1 is a conceptual module configuration view illustrating a configuration example of an exemplary embodiment;

FIG. 2 is an explanatory view illustrating a system configuration example using the exemplary embodiment;

FIG. 3 is a flowchart illustrating a process example according to the exemplary embodiment;

FIGS. 4A to 4C are explanatory views illustrating a process example according to the exemplary embodiment;

FIG. 5 is an explanatory view illustrating a data structure example of a co-occurrence probability table;

FIG. 6 is an explanatory view illustrating a process example according to the exemplary embodiment;

FIG. 7 is an explanatory view illustrating a data structure example of a co-occurrence probability table;

FIG. 8 is an explanatory view illustrating a data structure example of a tag frequency table;

FIG. 9 is a flowchart illustrating a process example according to the exemplary embodiment;

FIG. 10 is an explanatory view illustrating a process example according to the exemplary embodiment;

FIG. 11 is a flowchart illustrating a process example according to the exemplary embodiment;

FIG. 12 is an explanatory view illustrating a presentation example of a tag candidate menu; and

FIG. 13 is a block diagram illustrating a hardware configuration example of a computer for implementing the exemplary embodiment.

### DETAILED DESCRIPTION

First, before describing an exemplary embodiment, a process of generating training data using a premise of the exemplary embodiment or the exemplary embodiment will be described. Here, the description is intended to facilitate understanding of the exemplary embodiment.

There is a named entity recognition technique. In other words, the named entity recognition technique is a technique to automatically extract a proper noun from within a document and to estimate a type (hereinafter, also referred to as a “category”) of the extracted proper noun.

In the named entity recognition technique, in order to automatically extract a proper noun, training data which is correct answer data is needed. In general, after preparing a document in advance, an operator (also called an “annotator” or a “user”; hereinafter, referred to as a “user”) generates training data by a tagging operation.

For example, the following document (data) is prepared.

The All Japan Unified Championship of American football was held on the 18th at the Yokohama Dome, attracting 20,000 people.

Such a sentence is tagged by an operator as follows, thereby generating training data.

<Event>The All Japan Unified Championship</Event> of <Sports>American football</Sports> was held on the <Timex>18th</Timex> at <Facility>the Yokohama Dome</Facility>, attracting <Countx>20,000 people</Countx>.

Here, < > or </> is a tag, “Sport”, “Event”, and the like enclosed by < > or </> indicate the types of the tags, and the character strings enclosed by < > and </> indicates the respective tag types. For example, “American football” enclosed by <Sport> and </Sport> is a term of a sport type, “the All Japan Unified Championship” enclosed by <Event> and </Event> is the term of an Event type. Further, in this example, the event type and a facility type are the proper nouns.

When the training data is generated, there may be a case where tagging is erroneously performed as in the following example.

(1)<Company>The ABC bank is</Company>
(2)<Company>The ABC ba</Company>nk is

The example of (1) is an example in which an error in position occurs. It is possible to alert the abnormal when a tag boundary does not match its word separators (e.g. blank spaces).

However, an erroneous tag such as (2) affects a machine learning model, and the extraction accuracy of a unique expression deteriorates.

Such an error in tagging greatly adversely affects a machine learning model, and the extraction accuracy of a unique expression deteriorates.

Hereinafter, an example of an exemplary embodiment which is suitable for implementing the present invention will be described with reference to the accompanying drawings.

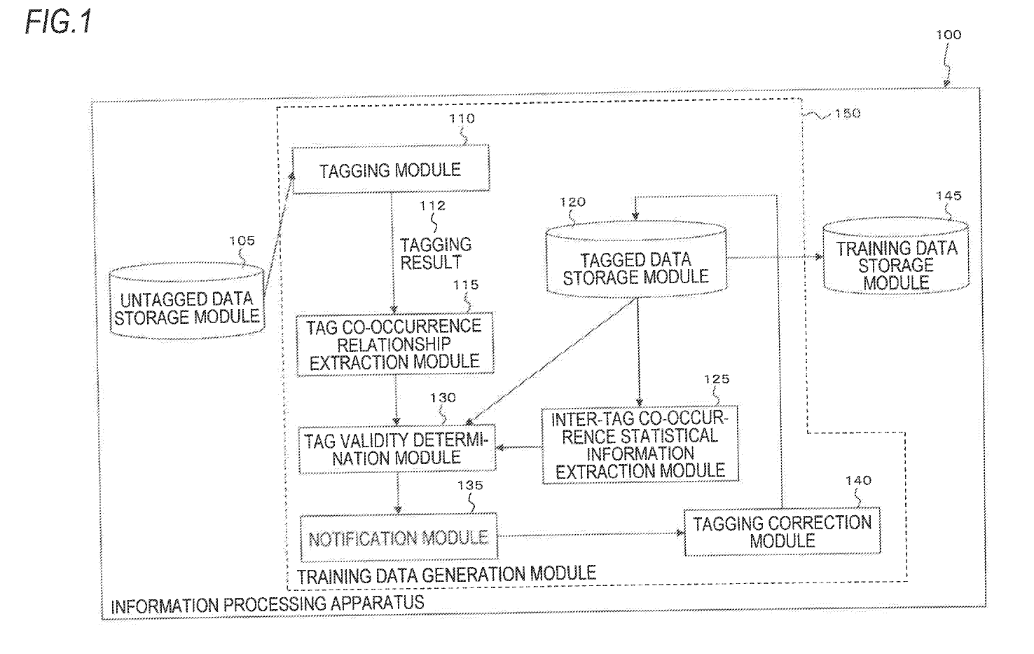

FIG. 1 is a conceptual module configuration view illustrating a configuration example of an exemplary embodiment.

Here, a “module” generally refers to a logically separable component such as software (a computer program) or hardware. Accordingly, the module in the exemplary embodiment refers to not only a module in the computer program, but also a module in a hardware configuration. Therefore, the exemplary embodiment also describes a computer program (a program causing a computer to execute respective procedures, a program causing a computer to function as respective units, and a program causing a computer to implement respective functions), a system and a method, which may serve as the modules. Meanwhile, for the convenience of explanation, “to store,” “to be stored,” and equivalent wordings are used. When the exemplary embodiment relates to a computer program, these wordings mean that the computer program is stored or controlled to be stored in a storage device. The modules may correspond to functions in a one-to-one relationship. Meanwhile, in implementation, one module may be implemented by one program, plural modules may be implemented by one program, and conversely, one module may be implemented by plural programs. The plural modules may be executed by one computer, or one module may be executed by plural computers in a distributed or parallel environment. One module may include another module. Hereinafter, a term “connection” is used for a case of not only a physical connection, but also a logical connection (a data exchange, an instruction, a reference relationship between data and the like). The term “predetermined” indicates that things are determined prior to a target process, and is used with the meaning that things are determined in accordance with a situation/state at that time or a situation/state until then as long as a target process is not yet performed before a process according to the exemplary embodiment starts or even after the process according to the exemplary embodiment starts. When there are plural “predetermined values,” the values may be different from each other, or two or more values (of course, including all the values) may be the same as each other. The statement “to carry out B when A” is used to mean “it is determined whether or not it is A, and when it is determined that it is A, B is carried out.” However, this excludes a case where it is not necessary to determine whether or not it is A. Enumeration of things such as “A, B, and C” indicates exemplary enumeration unless otherwise mentioned, which includes a case where only one (e.g., only A) is selected.

A configuration of a system or an apparatus may be implemented not only through connection between plural computers, hardware, apparatuses, and the like via a communication unit such as a network (including a one-to-one correspondence communication connection), but also through one computer, one hardware, one apparatus, and the like. An “apparatus” and a “system” are used synonymously with each other. Of course, the “system” does not include a system that is merely a social “structure” (a social system) as an artificial arrangement.

For each process in each module or each of plural processes in a case where the plural processes are performed in the module, target information is read from a storage device, and a process result is written in the storage device after the process is performed. Accordingly, descriptions for reading from a storage device prior a process, and writing to the storage device after the process may be omitted. In addition, a storage device herein may include a hard disk, a random access memory (RAM), an external storage medium, a storage device via a communication line, a register within a central processing unit (CPU), and the like.

An information processing apparatus 100 according to the exemplary embodiment performs tagging (also called “annotation”) on a document. As illustrated in an example of FIG. 1, the information processing apparatus 100 includes an untagged data storage module 105, a training data storage module 145, and a training data generation module 150. In particular, data for machine learning is generated using the tags. As described above, since tagging is performed by the operator, an error in tagging may occur. The information processing apparatus 100 extracts the erroneous tagging and notifies that the tag is abnormal. Further, a document (also referred to as a “file”) at least includes text data. The document may include numerical data, graphic data, image data, moving image data, audio data, and the like. The document is subject to storing, editing, searching, or the like. The document is exchangeable as individual units between systems or users. The document includes those similar thereto. Specifically, the document includes a document prepared by a document preparing program, an e-mail, a web page, or the like.

It is considered that contents are relatively unified in a unit document (for example, one article, one mail, or the like). That is, it can be said that the types of tags included in the same document are consistent. The information processing apparatus 100 according to the exemplary embodiment focuses on the relationship. The relationship may be, for example, a case where a possibility that a natural object (for example, a shoulder, a vanilla, or the like) is described in a topic of a company or economy is low, a case where a date and a place are liable to be described after an event, but an age is hardly described, and the like. The information processing apparatus 100 digitizes the co-occurrence relationship among tags appearing in the same document based on data that has already been tagged, and notifies that a tag is abnormal when the tag is not suitable for the relationship in a stage at which a target document is tagged (stage before adopting the target document as the training data).

The untagged data storage module 105 is connected to a tagging module 110 of the training data generation module 150. The untagged data storage module 105 stores documents from which the learning data in the machine learning is to be generated by the learning data generation module 150. That is, the untagged data storage module 105 stores a document to be tagged by the tagging module 110 from now and the like. For example, in general, the untagged data storage module 105 stores untagged documents. In addition, the untagged data storage module 105 may store a document a part of which is tagged, a document which is tagged but is not yet verified whether the tag is correct, or the like.

The learning data generation module 150 includes the tagging module 110, a tag co-occurrence relationship extraction module 115, a tagged data storage module 120, an inter-tag co-occurrence statistical information extraction module 125, a tag validity determination module 130, a notification module 135, and a tagging correction module 140.

The learning data generation module 150 (in particular, any one or more of the tag co-occurrence relationship extraction module 115, the inter-tag co-occurrence statistical information extraction module 125, and the notification module 135) may not handle a tag whose appearance frequency is high as a target. Here, the “tag whose appearance frequency is high” means a case where the appearance frequency of the tag is higher than or equal to or higher than a predetermined threshold. The appearance frequency may be simply the number of times the tag in interest appears in the document that has already been tagged (the document in which the tagging error is corrected) or a ratio of the number of times the tag in interest appears to the number of all tags in the document.

The tagging module 110 is connected to the untagged data storage module 105 and the tag co-occurrence relationship extraction module 115. The tagging module 110 hands over the document which is a tagging result 112 to the tag co-occurrence relationship extraction module 115. The tagging module 110 tags the document extracted from the untagged data storage module 105 according to a user's operation. For example, the tagging module 110 receives an operation by a user with respect to a mouse, a keyboard, a liquid crystal display serving as a touch panel, or the like to tag the document.

To tag the document extracted from the untagged data storage module 105, the tagging module 110 may present a tag extracted by the tag co-occurrence relationship extraction module 115 and a tag whose co-occurrence probability is high based on co-occurrence probability (a probability that plural (for example, 2) tags appear in a unit document) between the tags which is calculated with respect to the document which has already been tagged. The function is a function used for the tagging operation by the user. The “tag whose co-occurrence probability is high” is, for example, a tag whose co-occurrence probability is higher than or equal to or higher than a predetermined threshold or a tag whose co-occurrence probability is less than or equal to or less than a predetermined rank when the co-occurrence probabilities are sorted in a descending order (that is, a tag having an upper rank). Of course, if plural tags are presented, the tags may be sequentially presented in the descending order from the largest co-occurrence probability.

The tag co-occurrence relationship extraction module 115 is connected to the tagging module 110 and the tag validity determination module 130. The tag co-occurrence relationship extraction module 115 receives the tagging result 112 from the tagging module 110. The tag co-occurrence relationship extraction module 115 extracts tags that co-occur in the document of the tagging result 112. Here, the “tags that co-occur in the document” refers to a combination of plural (generally two; hereinafter, a case in which the number of tags is 2 will be exemplified) types of tags used in the document. That is, tags assigned in one document are extracted to recognize co-occurrence statuses of the tags.

The document to be targeted by the tag co-occurrence relationship extraction module 115 may include a “document which has already been tagged” (so-called a “document which becomes the learning data”) in “the co-occurrence probability between the tags which is calculated with respect to the document which has already been tagged” used by the inter-tag co-occurrence statistical information extraction module 125 in addition to the document which the user has tagged.

When the tag co-occurrence relationship extraction module 115 receives recognition that the tag notified by the notification module 135 is a correct tag by the user, the tag co-occurrence relationship extraction module 115 may process data before the tag or data after the tag. Here, for example, “a case where there is a change in content (topic)” corresponds to “the case of receiving the recognition that the tag notified by the notification module 135 is the correct tag by the user”. Therefore, the document is divided with the tag as a boundary. That is, after the content (topic) is changed, the learning data generation module 150 performs a process. Therefore, not the co-occurrence relationship in the entire document, but the co-occurrence relationship in the latter half becomes the target. Further, the learning data generation module 150 may perform the process even with respect to a part (a part before the tag) before the content (topic) is changed. In other words, the process by the learning data generation module 150 may be performed again with respect to the part that has already been processed. The reason is that since not the co-occurrence relationship in the entire document but the co-occurrence relationship in the first half becomes the target, the co-occurrence relationship is changed and there is a possibility that a tag to be notified abnormal is another tag. The abnormality indicates that there is a possibility that tagging is wrong. Specifically, although the probability that co-occurring tags appear is generally low, the co-occurring tag occurs in the target document.

The tagged data storage module 120 is connected to the inter-tag co-occurrence statistical information extraction module 125, the tag validity determination module 130, the tagging correction module 140, and the learning data storage module 145. The tagged data storage module 120 stores the co-occurrence probabilities between the tags which are calculated for the documents already tagged. Further, the tagged data storage module 120 stores a tagged document (a document with incorrect tagging being corrected) corrected by the tagging correction module 140. Then, the tagged document in the tagged data storage module 120 is stored in the learning data storage module 145 as data for machine learning. A timing of storing the tagged document from the tagged data storage module 120 in the learning data storage module 145 may be every time the tagged document is stored in the tagged data storage module 120, every predetermined period, or a time at which the predetermined number of tagged documents are stored.

Here, the co-occurrence probability may be a value calculated by normalization based on the appearance frequencies of tags or a probability in the co-occurrence relationship according to the order of the tags. Furthermore, in the latter (probability in the co-occurrence relationship according to the order of the tags), the co-occurrence probability may be a probability restricted to a tag just before or after a target tag. It is assumed that there is a relationship with the order of the tags. Specifically, the reason is that since it is likely to assign a date after or before an event, a tag indicating the date often appears immediately before or immediately after a tag indicating the event. Furthermore, in the latter (probability in the co-occurrence relationship according to the order of the tags), the co-occurrence probability may be a probability which is weighted according to a distance from a target tag. For example, a tag which is located three characters before the target tag (or three characters after the target tag) is weighted by 0.2, a tag which is located two characters before the target tag (or two characters after the target tag) is weighted by 0.5, and a tag which is located one character before the target tag (or one character after the target tag) is weighted by 1.0.

The inter-tag co-occurrence statistical information extraction module 125 is connected to the tagged data storage module 120 and the tag validity determination module 130. The inter-tag co-occurrence statistical information extraction module 125 extracts a co-occurrence probability or an expected value of the number of co-occurrences of the co-occurring tags which are extracted by the tag co-occurrence relationship extraction module 115, from the co-occurrence probability between the tags or the expected value of the number of the co-occurrences which is calculated with respect to the document already tagged. Further, as the co-occurrence probability between the tags which is calculated with respect to the documents already tagged, the co-occurrence probability stored in the tagged data storage module 120 may be used. In addition, the inter-tag co-occurrence statistical information extraction module 125 may calculate the co-occurrence probability between the tags for each document in the tagged data storage module 120. Then, the calculation result may be stored in the tagged data storage module 120. A conditional probability or the like may be calculated as the co-occurrence probability. For example, the probability that an Organization tag exists in a document in which a Time tag exists is calculated.

The tag validity determination module 130 is connected to the tag co-occurrence relationship extraction module 115, the tagged data storage module 120, the inter-tag co-occurrence statistical information extraction module 125, and the notification module 135. Based on the co-occurrence probability extracted by the inter-tag co-occurrence statistical information extraction module 125, the tag validity determination module 130 determines whether the co-occurring tags extracted by the tag co-occurrence relationship extraction module 115 are abnormal.

The tag validity determination module 130 compares a statistical value of the co-occurrence probability extracted by the inter-tag co-occurrence statistical information extraction module 125 with a predetermined threshold to determine whether to notify of abnormality.

Here, as the statistical value, any one of an average value, a mode value, a median value, a minimum value, and a weighted average value of the co-occurrence probabilities extracted by the inter-tag co-occurrence statistical information extraction module 125 or a combination thereof may be used. For example, when a certain tag (specifically, Per) is known to be important, the weighted average value may be used.

The notification module 135 is connected to the tag validity determination module 130 and the tagging correction module 140. Based on the co-occurrence probability extracted by the inter-tag co-occurrence statistical information extraction module 125, the notification module 135 notifies that the co-occurring tags extracted by the tag co-occurrence relationship extraction module 115 are abnormal. Further, the notification module 135 notifies that the tags are abnormal, in accordance with the determination result by the tag validity determination module 130. Here, the notification indicates that there is a high possibility that the target tag is erroneous. Examples of the “notification” include display on a display device such as a liquid crystal display or the like and an output as a 3D (dimensions) image. Furthermore, an output of sound by a sound output device such as a speaker or the like, vibration, and printing by a printing apparatus such as a printer may be combined. Of course, if it is determined by the tag validity determination module 130 that the notification is unnecessary, no notification is made.

The tagging correction module 140 is connected to the tagged data storage module 120 and the notification module 135. The tagging correction module 140 corrects the tag notified by the notification module 135 according to the operation of the user. The corrected tagged document is stored in the tagged data storage module 120. Further, if the tag is not notified by the notification module 135, the tagged document is stored in the tagged data storage module 120 without correction made by the user. In addition, even though it is notified that the tag is abnormal by the notification module 135 as described above, the tag may not be corrected by the user. In this case, the tag co-occurrence relationship extraction module 115 may process data before the tag or data after the tag again.

The learning data storage module 145 is connected to the tagged data storage module 120 of the learning data generation module 150. The learning data storage module 145 stores the document stored in the tagged data storage module 120 as the learning data for the machine learning.

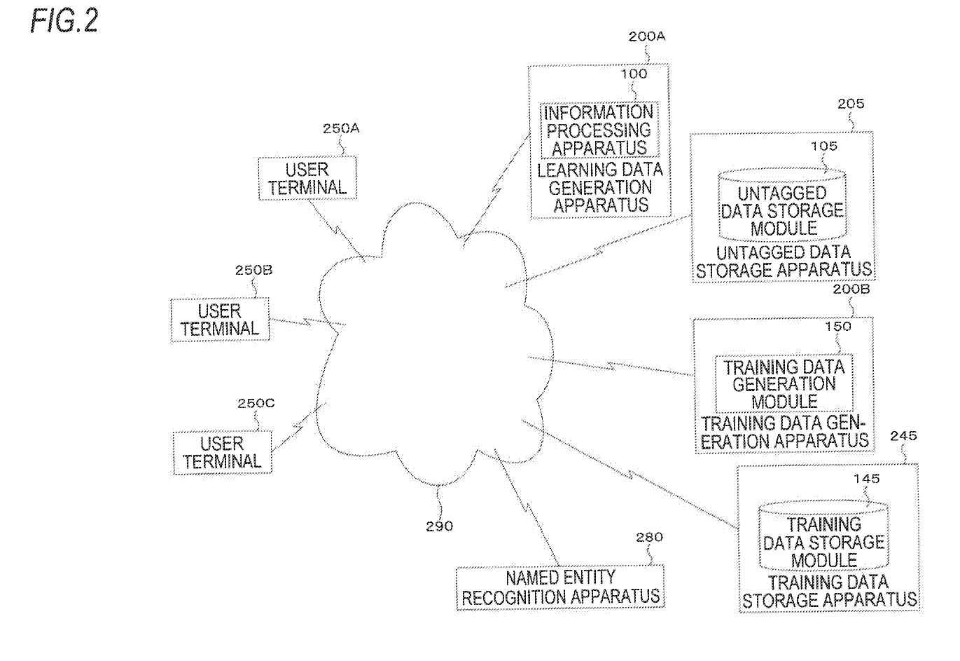

FIG. 2 is an explanatory view illustrating a system configuration example using the exemplary embodiment.

A learning data generation apparatus 200A, a learning data generation apparatus 200B, an untagged data storage apparatus 205, a learning data generation apparatus 245, a user terminal 250A, a user terminal 250B, a user terminal 250C, and a named entity recognition apparatus 280 are connected to each other via a communication line 290. The communication line 290 may be wireless, wired, or a combination thereof, and may be, for example, the Internet, intranet, or the like as a communication infrastructure. Further, functions provided by the learning data generation apparatus 200A, the learning data generation apparatus 200B, the untagged data storage apparatus 205, the learning data generation apparatus 245, and the named entity recognition apparatus 280 may be implemented as a cloud service. The learning data generation apparatus 200A has the information processing apparatus 100. The learning data generation apparatus 200B has the learning data generation module 150. The untagged data storage apparatus 205 has the untagged data storage module 105. The learning data generation apparatus 245 has the learning data storage module 145.

For example, the user terminal 250A is connected to the learning data generation apparatus 200A in accordance with the operation of the user and stores the learning data in the learning data storage module 145 in the learning data generation apparatus 200A by the process of the information processing apparatus 100. Then, the named entity recognition apparatus 280 performs the machine learning using the learning data of the learning data storage module 145 in the learning data generation apparatus 200A so as to generate a named entity recognition model. Then, the named entity recognition apparatus 280 extracts a proper noun from the document according to an instruction of the user from the user terminal 250.

By a coordination process among the untagged data storage apparatus 205 having the untagged data storage module 105, the learning data generation apparatus 200B having the learning data generation module 150, and the learning data generation apparatus 245 having the learning data storage module 145, the learning data may be accumulated in the learning data storage module 145 in the learning data generation apparatus 245. That is, for example, the user terminal 250B may be connected to the learning data generating apparatus 200B by the operation of the user, and the learning data may be accumulated in the learning data storage module 145 in the learning data generation apparatus 245 using the data of the untagged data storage module 105 in the untagged data storage apparatus 205 by the process of the learning data generation module 150. Then, the named entity recognition apparatus 280 may perform the machine learning using the learning data storage module 145 in the learning data generation apparatus 245 so as to generate the named entity recognition model.

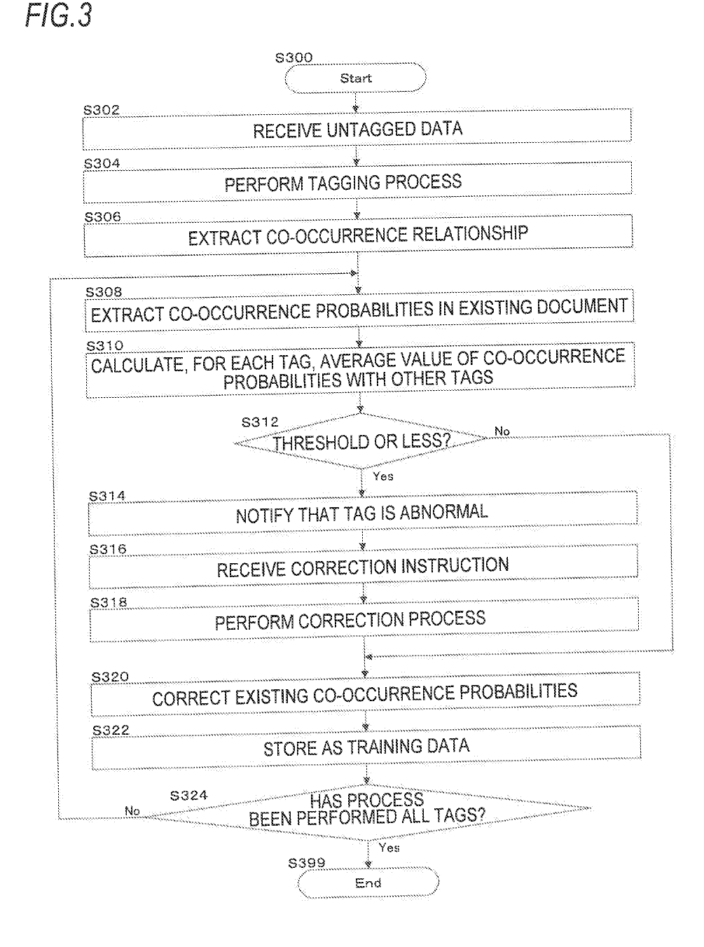

FIG. 3 is a flowchart illustrating a process example according to the exemplary embodiment.

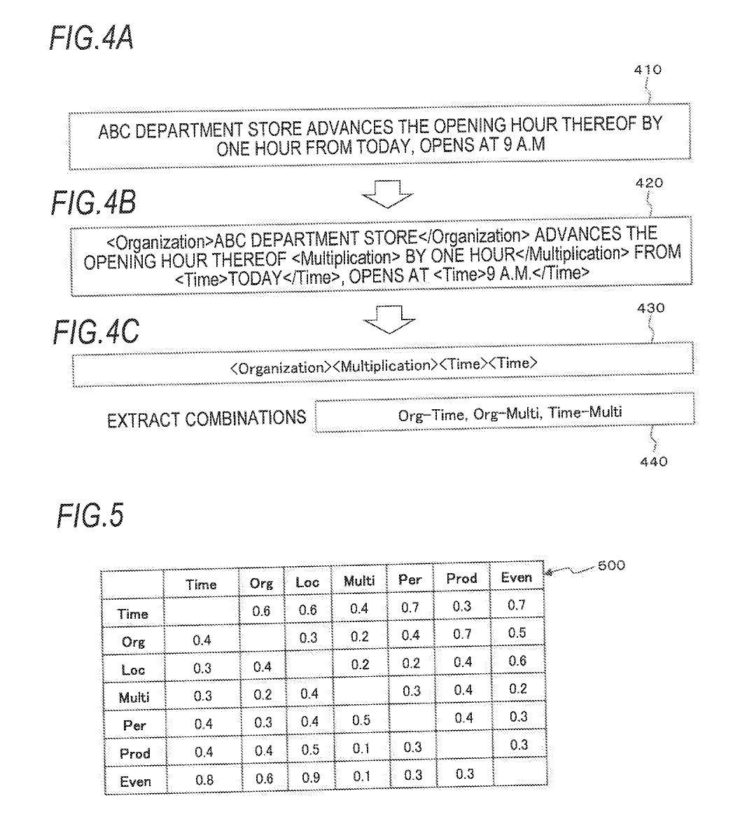

In step S302, the tagging module 110 receives untagged data (document) from the untagged data storage module 105. For example, the tagging module 110 receives untagged data 410 illustrated in FIG. 4A. Specifically, the untagged data 410 is “ABC department store advances its opening hour by one hour from today and opens at 9 a.m.”.

In step S304, the tagging module 110 performs a tagging process according to the operation of the user. For example, the tagging module 110 generates tagged data 420 from the untagged data 410 as illustrated in FIG. 4B. Specifically, the tagged data 420 is “<Organization>ABC department store </Organization> advances its opening hour by <Multiplication>one hour</Multiplication> from <Time>today</Time> and opens at <Time>9 a.m.</Time>.”.

In step S306, the tag co-occurrence relationship extraction module 115 extracts the co-occurrence relationship from the tagged data. For example, the tagging module 110 generates a tag extraction result 430 from the tagged data 420 as illustrated in FIG. 4C. Specifically, the tag extraction result 430 is “<Organization><Multiplication><Time><Time>”.

Then, combinations are extracted to generate co-occurrence tag combinations 440. Specifically, the co-occurrence tag combinations 440 are “Org (abbreviation for Organization)-Time”, “Org-Multi (abbreviation for Multiplication)” and “Time-Multi”.

In step S308, the inter-tag co-occurrence statistical information extraction module 125 extracts the co-occurrence probabilities in an existing document with respect to the combinations of the tags in the co-occurrence relationship extracted in step S306. Here, the existing document is a document tagged with no error (a document in which errors in tagging in the tagged data storage module 120 have been corrected). For example, the conditional co-occurrence probabilities are extracted from a co-occurrence probability table 500. FIG. 5 is an explanatory view illustrating an example of a data structure of the co-occurrence probability table 500. The co-occurrence probability table 500 stores the conditional probabilities for the combinations of two tags. That is, the co-occurrence probability table 500 shows conditional probabilities that a tag in each cell of a first row exists in a document, given that the document has tags in cells of a first column. For example, the cell (0.6) in the second row and the third column shows a probability that an Org tag exists in a document given that the document has a Time tag.

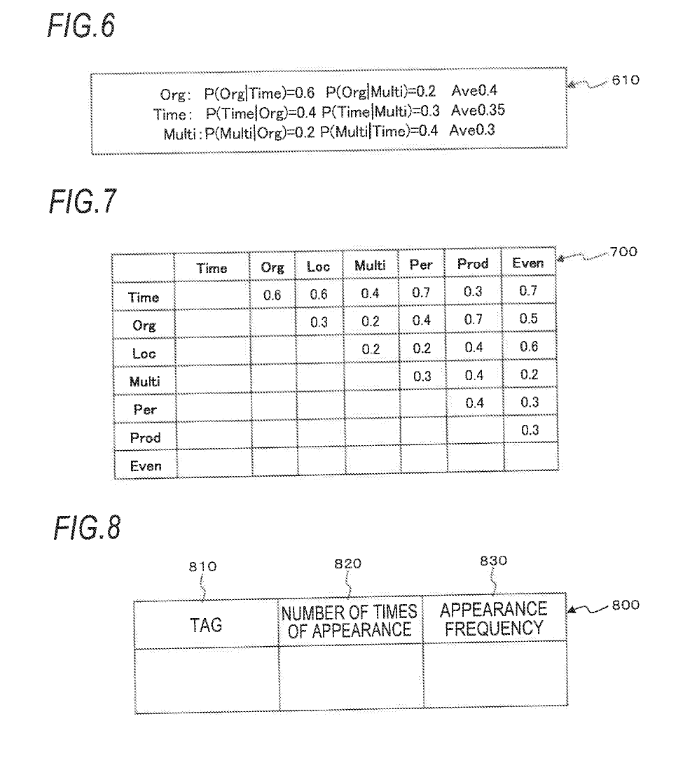

In step S310, the tag validity determination module 130 calculates, for each tag, an average value of co-occurrence probabilities with other tags. For example, as illustrated in FIG. 6, the tag validity determination module 130 calculates the average values of the conditional co-occurrence probabilities. That is, for each tag, attention is focused on the conditional probabilities between tags in the co-occurrence probability table 500. Specifically, for the Org tag, the conditional co-occurrence probability P (Org|Time)=0.6 and the conditional co-occurrence probability P (Org|Multi)=0.2 are extracted from the co-occurrence probability table 500, and the average value of 0.4 is calculated. For the Time tag, the conditional co-occurrence probability P (Org|Time)=0.4 and the conditional co-occurrence probability P (Time|Multi)=0.3 are extracted from the co-occurrence probability table 500, and the average value of 0.35 is calculated. For the Multi tag, the conditional co-occurrence probability P (Multi|Org)=0.2 and the conditional co-occurrence probability P (Multi|Time)=0.4 are extracted from the co-occurrence probability table 500, and the average value of 0.3 is calculated.

In step S312, the tag validity determination module 130 determines whether the average value of the co-occurrence probabilities with the other tags calculated in step S310 is equal to or less than a predetermined threshold. If the average value is equal to or less than the threshold, the process proceeds to S314. Otherwise, the process proceeds to step S320. For example, it is assumed that the predetermined threshold is set to “0.33.” Since the average value of the conditional co-occurrence probabilities for the Multi tag is “0.3,” the processes of step S314 and subsequent steps are performed for the Multi tag.

In step S314, the notification module 135 notifies that the tag is abnormal.

In step S316, the tagging correction module 140 receives a correction instruction.

In step S318, the tagging correction module 140 performs a correction process. In addition, the tagging correction module 140 stores corrected data in the tagged data storage module 120.

In step S320, the inter-tag co-occurrence statistical information extraction module 125 corrects the existing co-occurrence probabilities.

In step S322, the learning data storage module 145 stores the co-occurrence probabilities as the learning data.

In step S324, it is determined whether the process has been performed for all the tags. If the process has been performed for all the tags, the process ends (step S399). Otherwise, the process returns to step S308.

The co-occurrence probability table 500 illustrated in the example of FIG. 5 shows the conditional probabilities. Alternatively, a co-occurrence probability table 700 illustrated in an example of FIG. 7 may be used in step S308. The co-occurrence probability table 700 stores simple co-occurrence probabilities, rather than the conditional probabilities. That is, the co-occurrence probabilities represent probabilities that the respective combinations of two tags appear in one document. The co-occurrence probabilities are stored in the upper right half of the co-occurrence probability table 700.

The appearance order of tags is not taken into consideration in the co-occurrence probabilities in the co-occurrence probability table 500 and the co-occurrence probability in the co-occurrence probability table 700. Alternatively, the co-occurrence probabilities may be co-occurrence probabilities according to the order of the tags. That is, a co-occurrence probabilities that an A tag and a B tag occur in this order and a co-occurrence probability that the B tag and the A tag occur in this order may be separately calculated. Furthermore, the co-occurrence probabilities may be co-occurrence probabilities limited to a tag immediately before or immediately after a target tag.

In addition, the co-occurrence probabilities in the co-occurrence probability table 500 or the co-occurrence probability table 700 may be set to values which are normalized based on the appearance frequencies of tags. For example, the appearance frequency of each tag is managed by a tag frequency table 800. FIG. 8 is an explanatory view illustrating an example of a data structure of the tag frequency table 800. The tag frequency table 800 has a tag column 810, a number of times of appearances column 820, and an appearance frequency column 830. The tag column 810 stores a tag. The number of times of appearances column 820 stores the number of times the tag appears. The appearance frequency column 830 stores the appearance frequency of the tag.

In the tag frequency table 800, the appearance frequency is calculated by extracting a tag from a document already tagged (a document in the tagged data storage module 120), and measuring the number of times the tag appears. The appearance frequency is calculated by (the number of times the tag appears)/(the number of times all tags appear).

For the tag, the appearance frequency of which is greater than the predetermined threshold or equal to or greater than the predetermined threshold, none of the processes of step S306, step S308, and step S314 may be performed. This is because a tag having a high appearance frequency has a high co-occurrence probability in any document, such a tag does not contribute to the detection of an erroneous tag by the information processing apparatus 100.

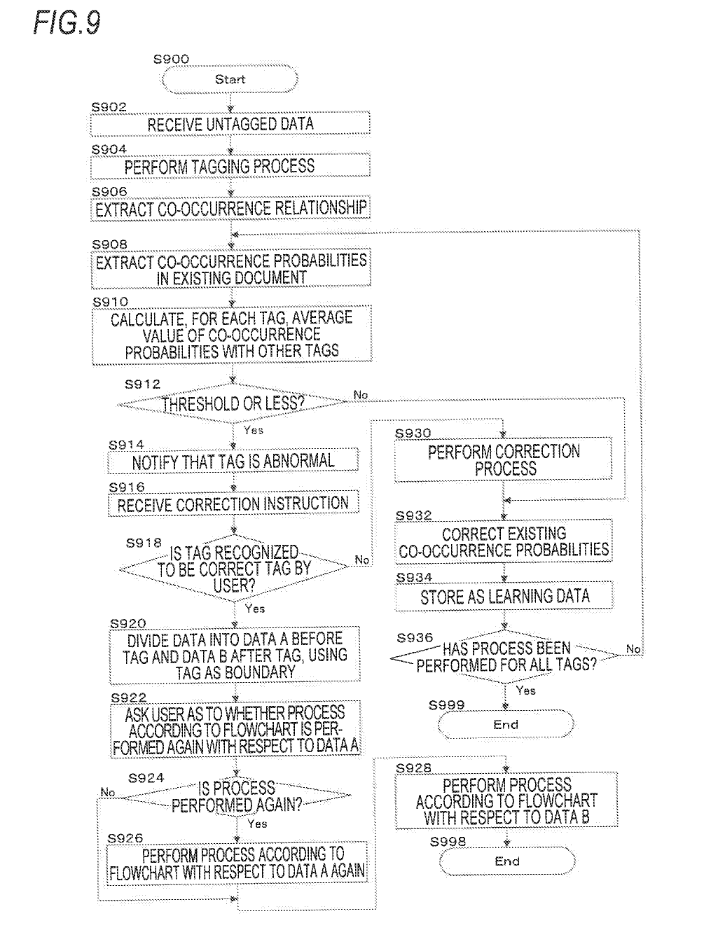

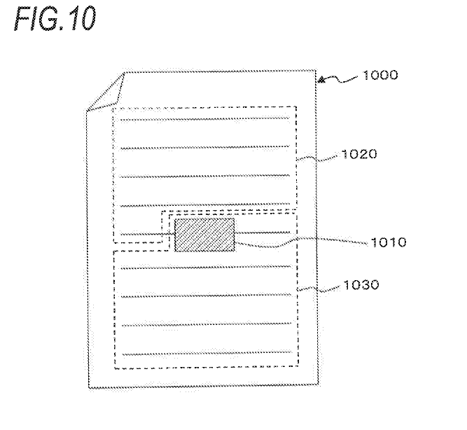

FIG. 9 is a flowchart illustrating a process example according to the exemplary embodiment. Processes from step S902 to step S916 are equivalent to the processes from step S302 to step S316 in the flowchart illustrated in the example of FIG. 3. In addition, processes from step S930 to step S936 are equivalent to the processes from step S318 to step S324 in the flowchart illustrated in the example of FIG. 3.

In step S902, the tagging module 110 receives untagged data from the untagged data storage module 105.

In step S904, the tagging module 110 performs the tagging process according to the operation of the user.

In step S906, the tag co-occurrence relationship extraction module 115 extracts the co-occurrence relationship from the tagged data.

In step S908, the inter-tag co-occurrence statistical information extraction module 125 extracts the co-occurrence probabilities in an existing document with respect to the combinations of the tags in the co-occurrence relationship extracted in step S906.

In step S910, the tag validity determination module 130 calculates, for each tag, an average value of co-occurrence probabilities with other tags.

In step S912, the tag validity determination module 130 determines whether the average value of the co-occurrence probabilities with the other tags calculated in step S910 is equal to or less than a predetermined threshold. If it is determined that the average value is equal to or less than the threshold, the process proceeds to S914. Otherwise, the process proceeds to step S932.

In step S914, the notification module 135 notifies that the tag is abnormal.

In step S916, the tagging correction module 140 receives a correction instruction.

In step S918, the tagging correction module 140 determines whether the tag is recognized as a correct tag by the user. If it is determined that the tag is recognized as the correct tag, the process proceeds to step S920. Otherwise, the process proceeds to step S930.

In step S920, the tagging correction module 140 divides data into data A before the tag and data B after the tag, using the tag as a boundary. For example, as illustrated in FIG. 10, if a target tag 1010 in a document 1000 is determined to be erroneous by the information processing apparatus 100, but it is recognized by the user that the tag is a correct tag (that is, no correction is made), the document 1000 is divided into (A) previous data 1020 which is data before the target tag 1010 and (B) post data 1030 which is data after the target tag 1010. This case corresponds to a case where a content that is not originally handled by one document 1000 (that is, a combination of tags which are notified as abnormal ones) is described.

In step S922, the tagging correction module 140 asks the user as to whether the process according to the flowchart is performed on the data A again.

If the user replies that the process is performed again in step S924, the process proceeds to step S926. Otherwise, the process proceeds to step S928.

In step S926, the process according to the flowchart is performed again on the data A. The process is performed again, but as a whole, the combinations of tags decrease and the unnecessary process of the tags thus decreases.

In step S928, the process according to the flowchart is performed on the data B. For the data B, in general, the combinations of tags decrease, and the unnecessary process of the tags thus decreases.

In step S930, the tagging correction module 140 performs the correction process. In addition, the tagging correction module 140 stores corrected data in the tagged data storage module 120.

In step S932, the inter-tag co-occurrence statistical information extraction module 125 corrects the existing co-occurrence probabilities.

In step S934, the learning data storage module 145 stores the co-occurrence probabilities as the learning data.

In step S936, it is determined whether the process has been performed for all the tags. If it is determined that the process has been performed for all the tags, the process ends (step S999). Otherwise, the process returns to step S908.

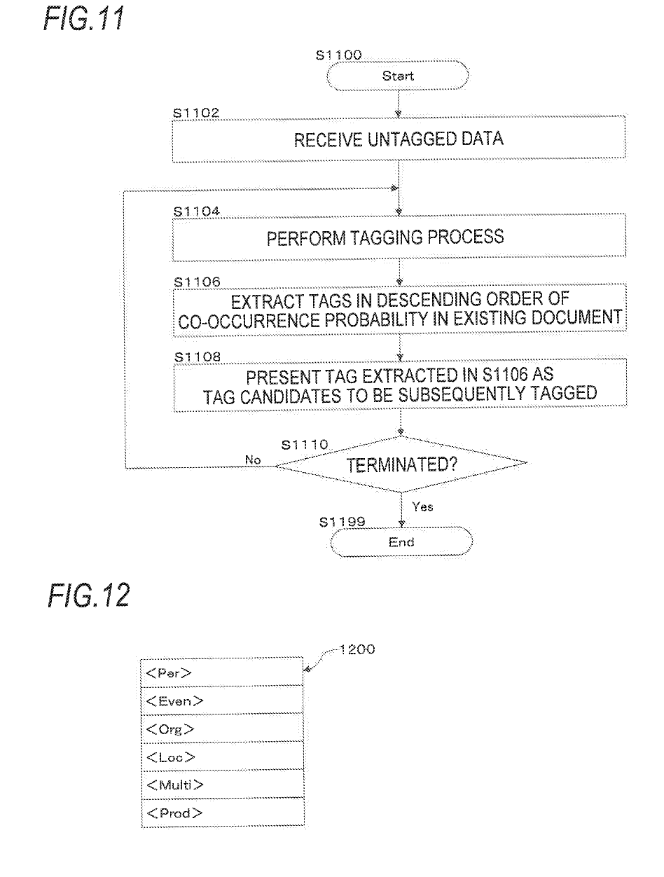

FIG. 11 is a flowchart illustrating a process example according to the exemplary embodiment (mainly for the tagging module 110).

In step S1102, the tagging module 110 receives the untagged data from the untagged data storage module 105.

In step S1104, the tagging process is performed according to the operation of the user. Further, the tagging process in step S1104 does not process all tags in the document like the tagging process in step S304 illustrated in the example of FIG. 3, but processes one tagging in accordance with the operation of the user. That is, every time one tagging is performed, the processes of step S1106 and subsequent steps are performed.

In the process in step S1104 second or subsequent time (the process in the case of returning with No in step S1110), a tag presented in step S1108 may be selected and the tagging process may be performed.

In step S1106, with respect to the tag, tags are extracted in the descending order of the co-occurrence probability in the existing document.

In step S1108, the tags extracted in step S1106 are presented as tag candidates to be subsequently tagged. For example, a tag candidate menu 1200 illustrated in FIG. 12 is presented. In the tag candidate menu 1200, the tags are arranged to be selectable in the descending order of the co-occurrence probability given that the <Time> tag exists, using the co-occurrence probability table 500 illustrated in the example of FIG. 5 after a process of assigning the <Time> tag. That is, the <Per> tag and the <Even> tag whose conditional probabilities given that the <Time> tag exists are 0.7, the <Org> tag and the <Loc> tag whose conditional probabilities given that the <Time> tag exists are 0.6, the <Multi> tag whose conditional probability given that the <Time> tag exists is 0.4, and the <Prod> tag whose conditional probability given that the <Time> tag exists is 0.3 are arranged in this order and presented. Any of the tags in the tag candidate menu 1200 is selected in accordance with the operation of the user, and then, the tagging process is performed.

In step S1110, it is determined whether the process is terminated. If it is determined that the process is terminated, the process ends (step S1199). Otherwise, the process returns to step S1104.

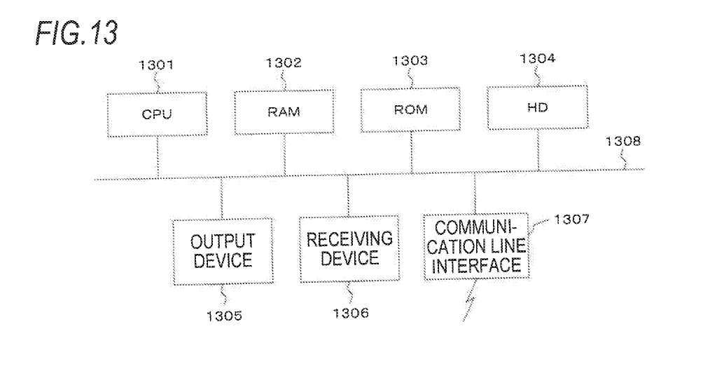

The hardware configuration of the computer on which the program of the exemplary embodiment is executed is a general computer, as exemplified in FIG. 13. Specifically, the hardware configuration of the computer is a personal computer, a computer that may be a server, or the like. That is, as a specific example, a CPU 1301 is used as a processing unit (arithmetic unit), and a RAM 1302, a ROM 1303, and an HD 1304 are used as the storage device. As the HD 1304, for example, a hard disk and a solid state drive (SSD) may be used. The hardware configuration is configured with the CPU 1301 that executes the programs of the tagging module 110, the tag co-occurrence relationship extraction module 115, the inter-tag co-occurrence statistical information extraction module 125, the tag validity determination module 130, the notification module 135, a tagging correction module 140, the learning data generation module 150, etc., the RAM 1302 that is stored with the program or data, the ROM 1303 that is stored with a program for activating the computer or the like, the HD 1304 which is a sub storage device (which may be a flash memory, or the like) having functions as the untagged data storage module 105, the tagged data storage module 120, and the learning data storage module 145, a receiving device 1306 that accepts data based on an operation of the user (including a motion, voice, a line of sight, etc.) with respect to a keyboard, a mouse, a touch screen, a microphone, a camera (including a line-of-sight detection camera, etc.), or the like, an output device 1305 such as a CRT, a liquid crystal display, a speaker, etc., a communication line interface 1307 that is configured to be connected to a communication network such as a network interface card, or the like, and a bus 1308 that connects the above-mentioned components to exchange data therebetween. The plural computers may be connected to each other by a network.

Among the above described exemplary embodiments, with respect to an exemplary embodiment based on a computer program, the system of the hardware configuration is caused to read the computer program as software and software and hardware resources cooperate with each other such that the exemplary embodiment is implemented.

The hardware configuration illustrated in FIG. 13 is merely one configuration example, but the exemplary embodiment is not limited to the configuration illustrated in FIG. 13 as long as a configuration where the modules described in the exemplary embodiment are executable is employed. For example, some modules may be implemented by dedicated hardware (e.g., an application specific integrated circuit (ASIC) or the like), and some modules may be in an external system and connected through a communication line. Further, plural systems illustrated in FIG. 13 may be connected to each other through the communication line so as to cooperate with each other. In particular, in addition to the personal computer, the configuration may be incorporated into a portable information communication device (including a cellular phone, a smart phone, a mobile device, a wearable computer, etc.), an information appliance, a robot, a copier, a facsimile, a scanner, a printer, a multifunction machine (an image processing apparatus having two or more functions of a scanner, a printer, a copying machine, and a facsimile), or the like.

In the comparison process in the description in the above described exemplary embodiment, the statements “equal to or larger than,” “equal to or smaller than,” “larger than,” and “smaller than (less than)” may be replaced with “larger than,” “smaller than (less than),” “equal to or greater than,” and “equal to or less than,” respectively, as long as there is no inconsistency in the combination.

In the example described above, the inter-tag co-occurrence statistical information extraction module 125 has been described using the example of extracting the co-occurrence probability, but an expected value of the number of co-occurrences may be used instead of the co-occurrence probability. This is because by considering the number of co-occurrences in a unit document, it is possible to distinguish a tag the number of co-occurrences of which is small and a tag the number of co-occurrences of which is large within the unit document. The “co-occurrence probability” may be changed to read as “expected value of the number of co-occurrences”. That is, the number of co-occurrences of each new data tag is counted using the expected value of the number of co-occurrences as values described in the co-occurrence probability table 500 and the co-occurrence probability table 700, and the abnormality may be detected using the distribution distance (KL information amount etc.), similarity (cosine similarity), and the like.

The above described program may be provided while being stored in a recording medium, or may be provided via a communication unit. In such a case, for example, the above described program may be regarded as an invention of “a computer-readable recording medium having a program written therein.”

The “computer-readable recording medium having a program written therein” refers to a computer-readable recording medium having a program written therein, which is used for installing, executing, and distributing the program.

Examples of the recording medium may include a digital versatile disc (DVD), e.g., “DVD-R, DVD-RW, DVD-RAM etc.” which are standards formulated in a DVD Forum, and e.g., “DVD+R, DVD+RW etc.” which are standards formulated in DVD+RW, a compact disc (CD), e.g., a read-only memory (CD-ROM), a CD recordable (CD-R), a CD rewritable (CD-RW) etc., a Blu-ray (registered trademark) disc, a magneto-optical disc (MO), a flexible disc (FD), a magnetic tape, a hard disk, a read only memory (ROM), an electrically erasable programmable read only memory (EEPROM (registered mark)), a flash memory, a random access memory (RAM), a secure digital (SD) memory card and the like.

The whole or a part of the above described program may be stored or distributed while being written on the above described recording medium. Also, the program may be transmitted through a communication, for example, using a wired network or a wireless communication network used for a local area network (LAN), a metropolitan area network (MAN), a wide area network (WAN), the Internet, an intranet, an extranet and the like, or using a transmission medium having a combination of these. Also, the program may be carried on a carrier wave.

Further, the above described program may be a part or the whole of another program, or may be written on a recording medium together with a separate program. Also, the program may be dividedly written on plural recording media. The program may be written in any manner such as compression or encryption, as long as the program is restorable.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a first extraction unit that extracts tags which co-occur in a document;
a second extraction unit that extracts a co-occurrence probability or an expected value of the number of co-occurrences of the co-occurring tags extracted by the first extraction unit from a co-occurrence probability or an expected value of the number of co-occurrences between the tags which is calculated with respect to a document which has already been tagged; and
a notification unit that notifies that the co-occurring tags extracted by the first extraction unit are abnormal based on the co-occurrence probability or the expected value of the number of co-occurrences extracted by the second extraction unit.

2. The information processing apparatus according to claim 1, wherein the notification unit compares a statistical value of the co-occurrence probability or the expected value of the number of co-occurrences extracted by the second extraction unit with a predetermined threshold, thereby determining whether to perform the notification.

3. The information processing apparatus according to claim 2, wherein
as the statistical value, any one of an average value, a mode value, a median value, a minimum value, and a weighted average value of the co-occurrence probability or the expected value of the number of co-occurrences extracted by the second extraction unit or a combination thereof is used, and
the notification unit performs the notification when the statistical value is less than the threshold or equal to or less than the threshold.

4. The information processing apparatus according to claim 1, wherein the co-occurrence probability or the expected value of the number of co-occurrences is a value calculated by normalization based on appearance frequencies of the tags.

5. The information processing apparatus according to claim 1, wherein the co-occurrence probability or the expected value of the number of co-occurrences is a probability or an expected value of the number of co-occurrences in a co-occurrence relationship according to an order of the tags.

6. The information processing apparatus according to claim 5, wherein the co-occurrence probability or the expected value of the number of co-occurrences is a probability or an expected value of the number of co-occurrences which is restricted to a tag immediately before or immediately after a target tag or a probability or an expected value of the number of co-occurrences which is weighted according to a distance from the target tag.

7. The information processing apparatus according to claim 1, wherein at least one of the first extraction unit, the second extraction unit, or the notification unit does not handle a tag having a high appearance frequency as a target.

8. The information processing apparatus according to claim 1, wherein if the tags notified by the notification unit are recognized to be correct tags by a user, a process by the first extraction unit is performed with respect to data before the tags or data after the tags.

9. The information processing apparatus according to claim 2, wherein if the tags notified by the notification unit are recognized to be correct tags by a user, a process by the first extraction unit is performed with respect to data before the tags or data after the tags.

10. The information processing apparatus according to claim 3, wherein if the tags notified by the notification unit are recognized to be correct tags by a user, a process by the first extraction unit is performed with respect to data before the tags or data after the tags.

11. The information processing apparatus according to claim 4, wherein if the tags notified by the notification unit are recognized to be correct tags by a user, a process by the first extraction unit is performed with respect to data before the tags or data after the tags.

12. The information processing apparatus according to claim 5, wherein if the tags notified by the notification unit are recognized to be correct tags by a user, a process by the first extraction unit is performed with respect to data before the tags or data after the tags.

13. The information processing apparatus according to claim 6, wherein if the tags notified by the notification unit are recognized to be correct tags by a user, a process by the first extraction unit is performed with respect to data before the tags or data after the tags.

14. The information processing apparatus according to claim 7, wherein if the tags notified by the notification unit are recognized to be correct tags by a user, a process by the first extraction unit is performed with respect to data before the tags or data after the tags.

15. An information processing apparatus comprising:
a first extraction unit that extracts a tag in a document; and
a presentation unit that, in tagging the document, presents a tag which is high in co-occurrence probability or expected value of the number of co-occurrences with the tag extracted by the first extraction unit, based on a co-occurrence probability or an expected value of the number of co-occurrences between tags which is calculated with respect to a document which has already been tagged.

16. An information processing apparatus comprising:
first extraction means for extracting tags which co-occur in a document;
second extraction means for extracting a co-occurrence probability or an expected value of the number of co-occurrences of the co-occurring tags extracted by the first extraction means from a co-occurrence probability or an expected value of the number of co-occurrences between the tags which is calculated with respect to a document which has already been tagged; and
notification means for notifying that the co-occurring tags extracted by the first extraction means are abnormal based on the co-occurrence probability or the expected value of the number of co-occurrences extracted by the second extraction means.
